(19) United States
(12) Patent Application Publication
(10) Pub. No.: US 2007/0088115 A1
(43) Pub. Date: Apr. 19, 2007

(54) Surface coat formula for solid surface composites

(76) Inventor: Donald R. Horn, Goodyear, AZ (US)

Correspondence Address: JAMES RAY & ASSOCIATES, 2640 PITCAIRN ROAD, MONROEVILLE, PA, 15146, US

(21) Appl. No.: 11/252,308

(22) Filed: Oct. 17, 2005

(51) Int. Cl. C08K 3/34

(52) U.S. Cl. 524/493

(57) ABSTRACT

A surface coat for a composite that can be used as counter tops, shower surrounds, bath tubs, sinks and various other commercial usages. The surface coat comprises a densified resin, such densified resin being present in a concentration of between about 81.5 and about 85.2 percent by weight. Methyl methacrylate is present in a concentration of between about 12.5 and about 15.1 percent by weight. There is an air release and wetting agent also present, such air release and wetting agent being present in a concentration of between about 0.75 and about 1.25 percent by weight. A mold release agent is present in a concentration of between about 0.15 and about 0.25 percent by weight and fumed silica is present in the formulation in a concentration of between about 1.4 and about 1.9 percent by weight.

### CROSS-REFERENCE TO RELATED APPLICATIONS

The invention taught in this patent application is closely related to the following co-pending U.S. patent applications, “Process for Making Solid Surface Composites” and “A Solid Surface Composite”. These co-pending application Ser. Nos. ______ and ______ were filed on July, 2005 and July, 2005. Further, the teachings of the above mentioned applications are incorporated herein by reference hereto.

### FIELD OF THE INVENTION

The present invention relates, in general, to a composition for counter tops, and more specifically, the present invention relates to a new formulation for a lightweight composite surface coat than can be used for counter tops, bath tubs, shower surrounds and various other commercial products for use in such areas as kitchen and bathrooms.

### BACKGROUND OF THE INVENTION

There are many materials that are used to form counter tops that are used in such areas as the kitchen or bathroom. Different materials have been used through the years to form tops that are both attractive and can withstand the use that such counter tops encounter, particularly kitchen counter tops.

One problem that has been generally plagued makers of counter tops and installers has been to make a good seal in the corner areas and the back splashes and any side splashes that may be used on the counter top. Another problem area that has been encountered is the union between the counter top and the sink. Still another problem is the weight that is involved with most counter tops which can create a problem for the installer. Thus, it would be desirable if there were a counter top that would eliminate the above problems.

### SUMMARY OF THE INVENTION

The present invention eliminates most of the problems described above by providing a surface coat for a composite that can be used as counter tops, shower surrounds, bath tubs, sinks and various other commercial usages. The surface coat comprises a densified resin, such densified resin being present in a concentration of between about 81.5 and about 85.2 percent by weight. Methyl methacrylate is present in a concentration of between about 12.5 and about 15.1 percent by weight. There is an air release and wetting agent also present, such air release and wetting agent being present in a concentration of between about 0.75 and about 1.25 percent by weight. A mold release agent is present in a concentration of between about 0.15 and about 0.25 percent by weight; and fumed silica is present in a concentration of between about 1.4 and about 1.9 percent by weight.

### OBJECTS OF THE INVENTION

It is, therefore, one of the primary objects of the present invention to provide a surface coat for light weight solid surface composites that can be used for kitchen and bathroom counter tops, shower surrounds, bathtubs, and other similar items.

Still another object of the present invention is to provide a surface coat for such lightweight composite that is very durable.

Yet another object of the present invention is to provide a surface coat for such lightweight composite that is very strong.

Another object of the present invention is to provide a surface coat for such lightweight composite that is atomized casted into a mold to form such composite.

These and various other objects and advantages of this invention will become apparent after a full reading of the following detailed description, particularly, when read in conjunction with the attached drawings as described below and the appended claims.

### BRIEF DESCRIPTION OF THE PRESENTLY PREFERRED AND ALTERNATE EMBODIMENTS OF THE INVENTION

The present invention eliminates many of the problems encountered in making a counter top. Thus, the present invention provides a surface coat for a solid surface composite that can be used as counter tops, shower surrounds, bath tubs, sinks and various other commercial products.

The surface coat comprises a densified resin, such densified resin being present in a concentration of between about 81.5 and about 85.2 percent by weight. It is presently preferred that such densified resin is a polyester resin. In a presently preferred embodiment of the invention such densified resin is present in a concentration of between about 82.5 and 84.5 percent by weight.

Such surface coat also includes methyl methacrylate. Such methyl methacrylate is present in a concentration of between about 12.5 and about 15.1 percent by weight. In a prefered embodiment of the invention such methyl methacrylate is present in a concentration of between about 12.75 and 14.5 percent by weight.

An air release and wetting agent is also present in the formulation of the surface coat. Such air release and wetting agent being present in a concentration of between about 0.75 and about 1.25 percent by weight. It is presently preferred that such concentration be between about 0.98 and about 1.09 percent by weight. One such air release and wetting agent is a product with the name 555 which is marketed by BYK, a German company.

The present invention also includes a mold release agent. Such mold release agent is present in the formulation of the surface coat in a concentration of between about 0.15 and about 0.25 percent by weight. In a preferred embodiment such mold release agent is present in a concentration of between about 0.19 and about 0.22 percent by weight. One such mold release agent is marketed as EQ-6 by Axel Company.

The formulation also includes fumed silica. Such fumed silica is present as a powdered resin fill to fill voids in the polyester resin matrix. Such fumed silica is present in a concentration of between about 1.4 and about 1.9 percent by weight. It is preferred that such fumed silica is present in a concentration of between about 1.5 and about 1.8 percent by weight. One such fumed silica as that used in the formulation is commercially available as Cab-osil.

It is also presently preferred that such formulation for the surface coat be applied by means of atomized casting. Thus, it is preferred that the surface coat be sprayed rather than poured as is done with many resins. The surface coat for a composite is preferably applied at a thickness of between about 1/16 and about 3/16 inches and even more preferred that the thickness be about ⅛ and about 3/16 inch or about 60-70 mils.

While both the presently preferred and a number of alternative embodiments of the present invention have been described in detail above it should be understood that various other adaptations and modifications of the present invention can be envisioned by those persons who are skilled in the relevant art without departing from either the spirit of the invention or the scope of the appended claims.

1. A surface coat having a predetermined thickness for a composite that can be used in at least one of a counter top, shower surround, bath tub, sink and various other commercial products, said surface coat comprising:
(a) a polyester resin, said polyester resin being present in a concentration of between about 81.5 and about 85.2 percent by weight;
(b) methyl methacrylate being present in a concentration of between about 12.5 and about 15.1 percent by weight;
(c) an air release and wetting agent, said air release and wetting agent being present in a concentration of between about 0.75 and about 1.25 percent by weight;
(d) a mold release agent being present in a concentration of between about 0.15 and about 0.25 percent by weight; and
(e) a fumed silica being present in a concentration of between about 1.4 and about 1.9 percent by weight.

2. (canceled)

3. The surface coat for a composite, according to claim 1, wherein said polyester resin is present in a concentration of between about 82.5 and 84.5 percent by weight.

4. The surface coat for a composite, according to claim 1, wherein said methyl methacrylate is present in a concentration of between about 12.75 and 14.5 percent by weight.

5. The surface coat for a composite, according to claim 1, wherein said air release and wetting agent being present in a concentration of between about 0.98 and about 1.09 percent by weight.

6. The surface coat for a composite, according to claim 1, wherein said mold release agent being present in a concentration of between about 0.19 and about 0.22 percent by weight; and

7. The surface coat for a composite, according to claim 1, wherein said fumed silica being present in a concentration of between about 1.4 and about 1.8 percent by weight.

8. The surface coat for a composite, according to claim 1, wherein said predetermined thickness of said surface coat is between about 1/16 and about 3/16 inches.

9. The surface coat for a composite, according to claim 8, wherein said predetermined thickness of said surface coat is between about ⅛ and about 3/16 inches.

10. The surface coat for a composite, according to claim 1, wherein said surface coat has a polished outer surface.

11. The surface coat for a composite, according to claim 1, wherein said polished outer surface is a gloss finish.
